(19) United States
(12) Patent Application Publication
(10) Pub. No.: US 2026/0359887 A1
(43) Pub. Date: Nov. 12, 2026

(54) REPLACEMENT PAYMENT CARD SYSTEM AND METHOD THEREFOR

(71) Applicant: Visa International Service Association, San Francisco, CA (US)

(72) Inventors: Kunal Kumar, Ghatotand (IN); Rahul Singhal, Bangalore (IN); Ritika Dogra, Bilaspur (IN)

(73) Assignee: Visa International Service Association, San Francisco, CA (US)

(21) Appl. No.: 19/201,848

(22) Filed: May 7, 2025

(51) Int. Cl. G06Q 40/02

(52) U.S. Cl. CPC G06Q 40/02

(57) ABSTRACT

In some embodiments, a computer-implemented method, includes receiving, at an electronic device, a replacement payment card request, the replacement payment card request being initiated by a payment cardholder to replace a payment card; ascertaining, from the payment cardholder at the electronic device, a personalized code (PC), the PC being associated with the payment cardholder; placing, at the electronic device, the PC in a replacement payment card authorization message associated with the replacement payment card request, the PC being configured for use authorizing the replacement payment card request initiated by the payment cardholder; providing, from the electronic device, the replacement payment card authorization message to an issuer of the payment card for authorization of the replacement payment card request; and based upon an affirmative authorization of the replacement payment card request, initiating a delivery of a replacement payment card to the payment cardholder.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Customers, especially those vacationing abroad, tend to lose things, such as, for example, wallets, smartphones, IDs, and payment cards. When a customer of a merchant loses a payment card and corresponding identification, it can be problematic, both for the merchant hoping to cash in on a customer's purchase and for the customers who may not have access to the requisite cash to purchase goods (especially in a foreign land). Typically, the customer is required to order a lost payment card utilizing, for example, an application on a smartphone. However, as stated previously, many customers have limited access to a smartphone because the smartphone has been lost or do not own a smartphone altogether. Thus, a need exists to provide and develop payment card systems that allow easy access to payment cards while being both secure and reliable.

### BRIEF DESCRIPTION OF THE DRAWINGS

FIG. 1A illustrates a block diagram of a system in accordance with some embodiments.

FIG. 1B illustrates a block diagram of a payment ecosystem that utilizes the system of FIG. 1A in accordance with some embodiments.

FIG. 2 illustrates a block diagram of a replacement payment card system in accordance with some embodiments.

FIG. 3 illustrates a replacement payment card method in accordance with some embodiments.

### DETAILED DESCRIPTION

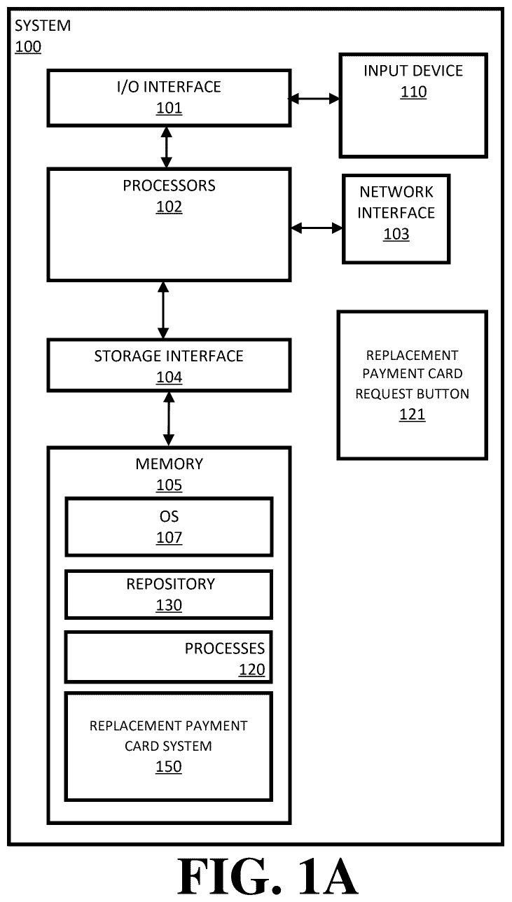

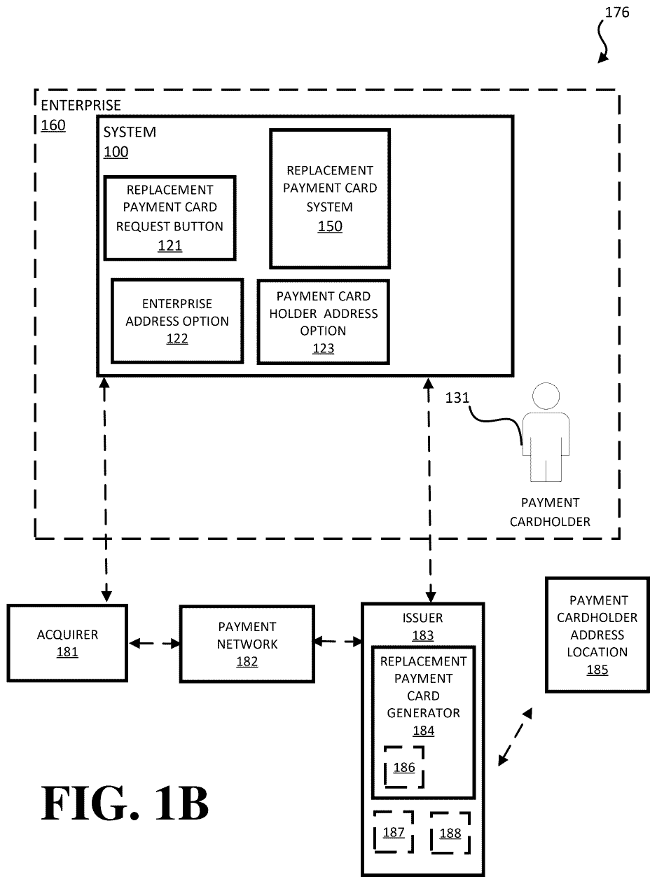

FIG. 1A illustrates a block diagram of an exemplary system 100 for implementing embodiments consistent with the present disclosure. In some nonlimiting embodiments or aspects, the system 100 may utilize a replacement payment card system 150 to implement a replacement payment card method, described further herein. In some embodiments, system 100 of payment network 182, illustrated in FIG. 1B, is configured to allow a payment cardholder 131 to securely order a replacement payment card 186 remotely from enterprise 160 that may be delivered to an address provided or selected by payment cardholder 131, as described further in detail herein. In some embodiments, system 100 may be, for example, a point-of-sale (POS) device or other type of electronic device, that in addition to being configured to perform the replacement card method described herein, is configured to perform payment transactions for enterprise 160. In some embodiments, system 100 is configured to operate in a payment ecosystem 176, illustrated by way of example in FIG. 1B, that allows system 100 to perform the replacement payment card operations described herein, as well as other payment transaction operations, such as, for example, purchasing merchandise and/or other services from enterprise 160.

In some embodiments, the processor/s 102 may comprise at least one data processors for executing program components for dynamic resource allocation at run time. The processors 102 may include specialized processing units such as integrated system (bus) controllers, memory management control units, floating point units, graphics processing units, digital signal processing units, etc.

In some embodiments, the processors 102 may be disposed in communication with one or more input/output (I/O) devices via an I/O interface 101. The I/O interface 101 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMi), RF antennas, S-Video, VGA, IEEE 802.1 n/b/g/n/x, Bluetooth®, cellular (e.g., code-division multiple access (CDMA), high-speed packet access (HSPA+), global system for mobile communications (GSM), long-term evolution (LTE), WiMax®, or the like), etc.

In some embodiments, using the I/O interface 101, the system 100 may communicate with one or more I/O devices. For example, an input device 110 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. An output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processors 102 may be disposed in communication with a communication network via a network interface 103. The network interface 103 may communicate with the communication network. The network interface 103 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network may include, without limitation, a direct interconnection, e-commerce network, a peer to peer (P2P) network, local area network (LAN), wide area network (WAN), wireless network (e.g., using Wireless Application Protocol), the internet, Wi-Fi®, etc. Using the network interface 103 and the communication network, the system 100 may communicate with the one or more service operators or other computers, issuer computers, acquirer computers, payment network computers, or customer smartphone and/or merchant smartphone, described further herein.

In some non-limiting embodiments or aspects, the processors 102 may be disposed in communication with a memory 105 (e.g., RAM, ROM, etc.) via a storage interface 104. In some embodiments, the storage interface 104 may connect to memory 105 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems interface (SCSI), etc. The memory drives may further include a drum, magnetic disc drive, magneto-optical drive, optical drive, Redundant Array of Independent Discs (RAID), solid-state memory devices, solid-state drives, etc.

In some embodiments, system 100 includes replacement payment card request button 121. In some embodiments, replacement payment card request button 121 is a button (e.g., a user-interface (UI) and/or a key-pad button) located or generated on an interface of system 100 that is configured to allow payment cardholder 131 to request a replacement payment card 186 utilizing replacement payment card system 150, described further herein. In some embodiments, replacement payment card request button 121 may be, for example, a request-a-replacement payment card prompt provided by system 100. In some embodiments, system 100 includes, in addition to replacement payment card request button 121, an enterprise address option 122 and a payment cardholder address option 123. In some embodiments, enterprise address option 122 is an option that is a UI or a key-pad button option located on and/or generated by system 100 that is configured to allow payment cardholder 131 to select an address of enterprise 160 for delivery of replacement payment card 186. In some embodiments, payment cardholder address option 123 is a UI or a key-pad button option located on and/or generated by system 100 that is configured to allow the payment cardholder 131 to input an address into system 100 for delivery of replacement payment card 186, described further herein.

In some embodiments, memory 105 may store a collection of program or database components, including, without limitation, a user interface, an operating system 107, a data repository 130, a web server, processes 120, replacement payment card system 150, etc., described further in detail herein. In some non-limiting embodiments or aspects, the system 100 may store user/application data, such as the data, variables, records, customer data, merchant data, customer smartphone data, merchant smarthphone data, etc.. as described in this disclosure. Such databases may be implemented as fault-tolerant, relational, scalable, secure databases such as Oracle or Sybase and/or a non-relational base, such as NoSQL.

In some embodiments, the operating system 107 may facilitate resource management and operation of the system 100. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® OS®, GOOGLE™ ANDROID™, or the like.

In some non-limiting embodiments or aspects, the system 100 may implement a web browser (not shown in the figures) stored program component. The web browser (not shown in the figures) may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, ADOBE® FLASH®, JAVASCRIPT®, JAVA®, Application Programming Interfaces (APIs), etc.

Furthermore, one or more computer-readable storage media may be utilized in implementing embodiments consistent with the present disclosure. In some embodiments, a computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

FIG. 1B illustrates a block diagram of a payment ecosystem 176 in accordance with some embodiments. In some embodiments, payment ecosystem 176 is a payment ecosystem for processing payments configured to allow a payment cardholder 131 to utilize replacement payment card system 150 of system 100 to order a replacement payment card 186 that is delivered to payment cardholder 131 at enterprise 160 or another payment address location indicated by payment cardholder 131 (e.g., payment cardholder adress location 185). In some embodiments, replacement payment card 186 is a payment card (e.g., a VISA credit card or VISA debit card, etc.) that has been authorized as a replacement for a payment card associated with payment cardholder 131 utilizing replacement payment card system 150 of system 100.

In some embodiments, payment ecosystem 176 includes an enterprise 160, an acquirer 181, a payment network 182, and an issuer 183. As illustrated, a payment cardholder address location 185 (also included in FIG. 1B) is a physical location associated with a mailing address that payment cardholder 131 may provide for delivery of replacement payment card 186, described further herein. In some embodiments, enterprise 160 is a commercial entity that includes system 100 that, in addition to being configured to allow payment cardholder 131 to utilize replacement payment card system 150 to order replacement payment card 186, is configured to conduct payment transactions via payment ecosystem 176. In some embodiments, enterprise 160 is or may be a merchant, a hotel, an airport, or any other type of enterprise configured to utilize replacement payment card system 150 in system 100 to allow payment cardholder 131 to order and receive a replacement payment card, such as for example, replacement payment card 186. In some embodiments, acquirer 181 is a financial institution or entity that processes payment transactions in payment ecosystem 176 on behalf of enterprise 160 and receives authorization and settlement from payment network 182 and/or issuer 183. In some embodiments, payment network 182 is a computer-implemented financial transaction processing system, such as, for example, VISA, that facilitates the authorization, clearing, and settlement of payment transactions between issuer 183, acquirer 181, enterprise 160, and payment cardholder 131. In some embodiments, issuer 183 is a financial institution that provides payment cards to consumers, such as, for example, payment cardholder 131, and may be responsible for authorizing transactions and funding payments made using a payment card associated with payment cardholder 131. In some embodiments, as illustrated, payment cardholder 131 utilizes replacement payment card system 150 of system 100 to order a replacement payment card 186 at enterprise 160 that may be delivered to either enterprise 160 or payment cardholder address location 185, as described further herein.

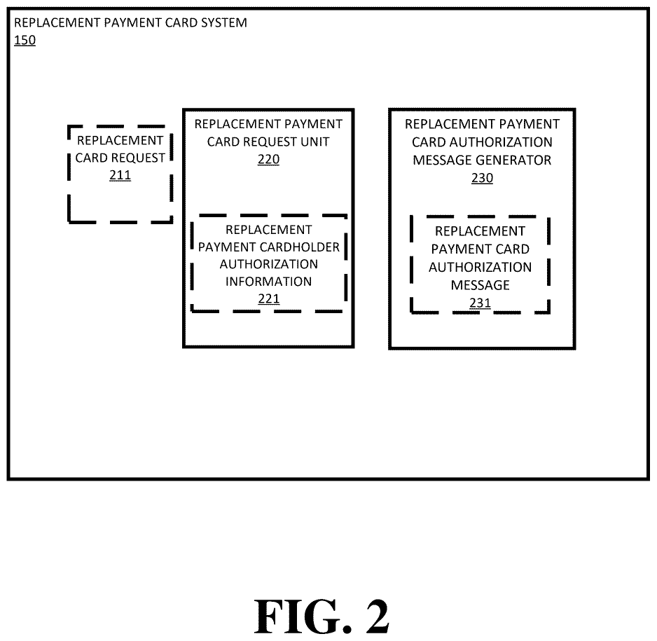

FIG. 2 illustrates a block diagram of replacement payment card system 150 in accordance with some embodiments. In some embodiments, replacement payment card system 150 is executable code and/or equivalent hardware associated with enterprise 160 (e.g., an airport, a hotel, etc) that is configured to allow a payment cardholder 131 to order a replacement payment card 186 to be delivered to a location indicated by the payment cardholder 131 (e.g., an enterprise address or a payment cardholder address (e.g., payment cardholder address location 185)). In some embodiments, the enterprise address is an address associated with enterprise 160 that is configured to receive a replacement payment card 186 for payment cardholder 131. For example, in some embodiments, the enterprise address may be the physical address of enterprise 160. In some embodiments, the payment cardholder address is an address provided by payment cardholder 131 to system 100 that is utilized to receive replacement payment card 186 for payment cardholder 131.

In some embodiments, replacement payment card system 150 includes a replacement payment card request unit 220 and a replacement payment card authorization message generator 230. In some embodiments, replacement payment card request unit 220 is executable code configured to execute operations utilized to request a replacement payment card (e.g., replacement payment card 186) for payment cardholder 131. In some embodiments, as stated previously, replacement payment card 186 is a payment card (e.g., VISA credit card, etc.) that authorized by, for example, issuer 183, as a replacement for a payment card associated with payment cardholder 131. In some embodiments, replacement payment card authorization message generator 230 is executable code configured to generate a replacement payment card authorization message 231 that is provided to issuer 183 for verification and replacement of a payment card for payment cardholder 131. In some embodiments, replacement payment card authorization message 231 is an authorization message generated by replacement payment card authorization message generator 230 that is configured to include information that allows a replacement payment card 186 to be ordered by payment cardholder 131 at system 100. In some embodiments, the replacement payment card authorization message 231 is configured to be transmitted to issuer 183 (e.g., the issuer of the payment card to payment cardholder 131) via acquirer 181 (e.g., the bank associated with enterprise 160) and payment network 182 (e.g., VISA) for use in authorizing the replacement of a payment card for payment cardholder 131.

In some embodiments, in operation, payment cardholder 131 initiates a replacement payment card request 211 by, for example, pressing replacement payment card request button 121 on an interface of system 100, as illustrated in FIG. 1B. In some embodiments, replacement payment card request 211 is a replacement payment card activation signal (activated utilizing replacement payment card request button 121) that is configured to operate as a request for a replacement of a payment card associated with payment cardholder 131. In some embodiments, replacement payment card request unit 220 receives the replacement payment card request 211 and commences the process of ascertaining replacement payment cardholder authorization information 221 from payment cardholder 131. In some embodiments, replacement payment cardholder authorization information 221 is authorization information provided by payment cardholder 131 to replacement payment card request unit 220 that is used to verify whether payment cardholder 131 is authorized to order and receive a replacement payment card 186.

z

In some embodiments, after receiving the replacement payment cardholder authorization information 221, replacement payment card request unit 220 provides an enterprise address option 122 and a payment cardholder address option 123 to payment cardholder 131 via an interface on system 100. In some embodiments, as stated previously, enterprise address option 122 is an option that is a UI or a key-pad button option located on and/or generated by system 100 that is configured to allow payment cardholder 131 to select an address of enterprise 160 for delivery of the replacement payment card 186. In some embodiments, as stated previously, payment cardholder address option 123 is a UI or a key-pad button option located on and/or generated by system 100 that is configured to allow the payment cardholder 131 to input an address into system 100 for delivery of the replacement payment card 186. In some embodiments, when payment cardholder 131 selects enterprise address option 122, the enterprise address (previously stored in system 100 during, for example, boot up of system 100) is ascertained from, for example, memory 105, by replacement payment card request unit 220. In some embodiments, when payment cardholder 131 selects payment cardholder address option 123, the payment cardholder address is ascertained from payment cardholder 131 by replacement payment card request unit 220 at system 100.

In some embodiments, after receiving the replacement payment cardholder authorization information 221 and the enterprise address or payment cardholder address from payment cardholder 131, replacement payment card request unit 220 places the payment cardholder information and enterprise address or payment cardholder address into a replacement payment card authorization message 231. In some embodiments, replacement payment card authorization message 231 is a replacement payment card authorization message generated by replacement payment card authorization message generator 230 that is specifically configured to allow for the request of a replacement payment card at system 100. In some embodiments, the replacement payment card authorization message 231 may be configured to operate under various standards, such as, for example, International Organization for Standardization (ISO) (e.g., ISO 8583) or Universal Secure Payments (USP) (e.g., USP 20022) for payment related transactions. In some embodiments, in addition to including the general ISO standards fields required for payment network transmissions, the replacement payment card authorization message 231 includes a field that is configured to indicate that a replacement payment card request is being requested (e.g., replacement payment card indicator field), a field that stores replacement payment cardholder authorization information 221 (e.g., payment cardholder information field/s), a field for the enterprise address (e.g., enterprise address field), and a field for the payment cardholder address (e.g., payment cardholder address field). In some embodiments, placement of the replacement payment card indicator in the replacement payment card indicator field, placement of the payment cardholder information in the payment cardholder information fields, placement of the enterprise address in the enterprise address field, and/or placement of the payment cardholder address in the payment cardholder address field, allow issuer 183 to assess the prescribed fields and pertinant information (e.g., replacement payment cardholder authorization information 221) to determine whether replacement of the requested payment card is authorized. In some embodiments, after placing the replacement payment cardholder authorization information 221 and address information in the replacement payment card authorization message 231, replacement payment card request unit 220 provides replacement payment card authorization message 231 to issuer 183 via acquirer 181 and payment network 182.

In some embodiments, issuer 183 receives the replacement payment card authorization message 231 and commences the process of verifying the identity of the payment cardholder 131 for authorization purposes. In some embodiments, issuer 183 verifies the identity of payment cardholder 131 by performing an enterprise-based replacement payment card authorization assessment of the replacement payment card authorization message 231. In some embodiments, issuer 183 performs the enterprise-based replacement payment card authorization assessment by comparing the replacement payment cardholder authorization information 221 ascertained at enterprise 160 with replacement payment cardholder authorization information 221 stored at issuer 183. For example, issuer 183 may compare the photographic information and/or biometric information provided with stored photographic information (and/or biometric information) at issuer 183 and when there is an affirmative match, the replacement payment card request may be authorized. In some embodiments, as part of the enterprise-based replacement payment card authorization assessment, issuer 183 may verify previous payment card activity associated with the payment cardholder 131, etc. In some embodiments, after verifying the replacement payment cardholder authorization information 221 utilizing the enterprise-based replacement payment card authorization assessment, issuer 183 provides a replacement payment card authorization message 187 to system 100 (via a payment network 182 and acquirer 181 associated with enterprise 160). In some embodiments, replacement payment card authorization message 187 is an authorization message generated by issuer 183 that is configured to indicate to replacement payment card system 150 of system 100 and payment cardholder 131 that a replacement payment card 186 has been authorized (or not authorized) by issuer 183.

In some embodiments, replacement payment card system 150 receives the replacement payment card authorization message 187 from issuer 183 and assesses (e.g., via an authorization field in the replacement payment card authorization message 187) replacement payment card authorization message 187 to determine if the replacement payment card 186 has been authorized. In some embodiments, when replacement payment card system 150 determines that the replacement payment card 186 has been authorized, replacement payment card system 150 notifies payment cardholder 131 via system 100 that the replacement payment card 186 has been authorized and is to be delivered to the address location provided by payment cardholder 131. In addition, in some embodiments, when the replacement payment card 186 has been authorized, issuer 183 provides a replacement payment card message 188 to replacement payment card generator 184, which is a replacement payment card message that indicates that a payment card is to be manufactured and delivered to payment cardholder 131 (e.g., Card Personalization Request (CPR)). In some embodiments, for example, replacement payment card generator 184 may be a third-party manufacturer authorized by issuer 183 to generate or manufacture replacement payment card 186. In some embodiments, replacement payment card generator 184 receives the replacement payment card message 188 from issuer 183 and generates replacement payment card 186 for payment cardholder 131.

In some embodiments, after generating the replacement payment card 186, the replacement payment card generator 184 delivers the replacement payment card 186 to the address provided by the payment cardholder 131, which may be, for example, the address of enterprise 160 or the address of the payment cardholder 131. In some embodiments, when replacement payment card system 150 determines that the replacement payment card has not been authorized, replacement payment card system 150 notifies payment cardholder 131 via system 100 that the request for replacement payment card 186 has not been authorized and a replacement payment card will not be delivered to payment cardholder 131.

Utilization of the embodiments described herein serve as an improvement over other computerized payment processing transaction systems in that, for example, the embodiments may be utilized to improve the efficiency of legacy systems within a payment ecosystem. For example, instead of having to completely replace a current POS device in a payment ecosystem, an enterprise, such as enterprise 160, is able implement the embodiments described herein in an existing POS infrastructure or system to allow a payment cardholder to order a replacement payment card at the enterprise, and generate additional revenue for the enterprise, payment network, issuer, etc. Thereby, improving efficiency in payment processing systems and eliminating the need for the use of additional electronic devices and/or independent software.

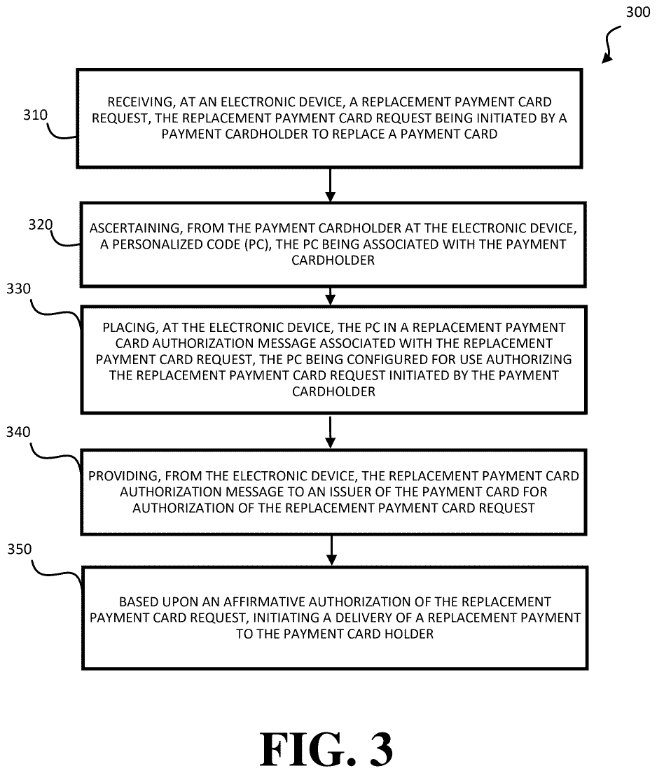

FIG. 3 illustrates a replacement payment card generation method 300 in accordance with some embodiments. In some embodiments, the replacement payment card generation method 300 is configured to allow payment cardholder 131 to utilize replacement payment card system 150 to request a replacement payment card at a location designated by the payment cardholder 131 at system 100. In some embodiments, the replacement payment card generation method 300 is executed by replacement payment card system 150. The method, process steps, or stages illustrated in FIG. 3 may be implemented as an independent routine or process, or as part of a larger routine or process. Note that each process step or stage depicted may be implemented as an apparatus that includes a processor executing a set of instructions, a method, or a system, among other embodiments. In some embodiments, replacement payment card generation method 300 is described with reference to FIG. 1A-FIG. 3.

In some embodiments, with reference to FIGS. 1A-3 , at operation 310, replacement payment card request unit 220 of replacement payment card system 150 receives a replacement payment card request 211. In some embodiments, as stated previously, the replacement payment card request 211 is initiated by a payment cardholder 131 utilizing replacement payment card request button 121 to replace a payment card associated with the payment cardholder 131.

In some embodiments, at operation 320, replacement payment card request unit 220 ascertains, from the payment cardholder 131 at system 100, a PC, the PC being associated with payment cardholder 131.

In some embodiments, at operation 330, replacement payment card authorization message generator 230 places, at system 100, the PC in a replacement payment card authorization message 231 associated with the replacement payment card request 211, the PC being configured for use in authorizing the replacement payment card request 211 initiated by the payment cardholder 131.

In some embodiments, at operation 340, replacement payment card authorization message generator 230 provides, from system 100, the replacement payment card authorization message 231 to issuer 183 of the payment card for authorization of the replacement payment card request 211. In some embodiments, at operation 350, based upon an affirmative authorization of the replacement payment card request, issuer 183 initiates a delivery of a replacement payment card 186 to payment cardholder 131.

In some embodiments, a computer-implemented method includes receiving, at an electronic device, a replacement payment card request, the replacement payment card request being initiated by a payment cardholder to replace a payment card; ascertaining, from the payment cardholder at the electronic device, a personalized code (PC), the PC being associated with the payment cardholder; placing, at the electronic device, the PC in a replacement payment card authorization message associated with the replacement payment card request, the PC being configured for use authorizing the replacement payment card request initiated by the payment cardholder; providing, from the electronic device, the replacement payment card authorization message to an issuer of the payment card for authorization of the replacement payment card request; and based upon an affirmative authorization of the replacement payment card request, initiating a delivery of a replacement payment card to the payment cardholder.

In some embodiments of the computer-implemented method, the electronic device is associated with a merchant.

In some embodiments of the computer-implemented method, the replacement payment card is delivered to the payment cardholder via the merchant.

In some embodiments of the computer-implemented method, the PC is a payment-card-holder-specific PC unique to the payment cardholder.

In some embodiments of the computer-implemented method, the payment-card-holder-specific PC includes a pin code.

In some embodiments of the computer-implemented method, the electronic device is a point-of-sale (POS) device.

In some embodiments of the computer-implemented method, the electronic device is configured to display an option to allow the payment cardholder to initiate the replacement payment card request.

In some embodiments of the computer-implemented method, the electronic device is an automated teller machine (ATM) or a kiosk.

In some embodiments, a method includes configuring an electronic device to allow a payment cardholder to request a replacement payment card; providing, at the electronic device, a request-a-replacement payment card prompt, the request-a-replacement payment card prompt being configured to allow the payment cardholder to request the replacement payment card; ascertaining, upon selection of the request-a-replacement payment card prompt by the payment cardholder, replacement payment cardholder authorization information 221; and utilizing the replacement payment cardholder authorization information to authorize a delivery of the replacement payment card for use by the payment cardholder.

In some embodiments of the method, the electronic device is a point-of-sale (POS) device.

In some embodiments of the method, the electronic device is associated with a merchant.

In some embodiments of the method, the replacement payment card is delivered to the payment cardholder via the merchant.

In some embodiments of the method, the replacement payment cardholder authorization information includes a payment-card-holder-specific personalized code (PC) unique to the payment cardholder.

In some embodiments of the method, the replacement payment card is delivered to the payment cardholder via the merchant.

In some embodiments of the method, the payment-card-holder-specific PC includes a pin code.

In some embodiments of the method, the electronic device is an automated teller machine (ATM) or a kiosk.

In some embodiments, a system includes a processor; and a non-transitory computer readable medium coupled to the processor, the non-transitory computer readable medium including code that: receives, from an electronic device, a replacement payment card request; ascertains, as part of the replacement payment card request, a personalized code (PC) associated with a payment cardholder; confirms an identity of the payment cardholder utilizing the PC in a replacement payment card authorization message; based on the confirmation of the identity of the payment cardholder, provides the payment cardholder with a replacement payment card to an address indicated by the payment cardholder.

In some embodiments of the system, the electronic device is associated with a merchant.

In some embodiments of the system, the replacement payment card is delivered to the payment cardholder via the merchant.

In some embodiments of the system, the PC is a payment-card-holder-specific PC unique to the payment cardholder.

What is claimed is:

1. A computer-implemented method, comprising:
receiving, at an electronic device, a replacement payment card request, the replacement payment card request being initiated by a payment cardholder to replace a payment card;
ascertaining, from the payment cardholder at the electronic device, a personalized code (PC), the PC being associated with the payment cardholder;
placing, at the electronic device, the PC in a replacement payment card authorization message associated with the replacement payment card request, the PC being configured for use authorizing the replacement payment card request initiated by the payment cardholder;
providing, from the electronic device, the replacement payment card authorization message to an issuer of the payment card for authorization of the replacement payment card request; and
based upon an affirmative authorization of the replacement payment card request, initiating a delivery of a replacement payment card to the payment cardholder.

2. The computer-implemented method of claim 1, wherein:
the electronic device is associated with a merchant.

3. The computer-implemented method of claim 2, wherein:
the replacement payment card is delivered to the payment cardholder via the merchant.

4. The computer-implemented method of claim 3, wherein:
the PC is a payment-card-holder-specific PC unique to the payment cardholder.

5. The computer-implemented method of claim 4, wherein:
the payment-card-holder-specific PC includes a pin code.

6. The computer-implemented method of claim 5, wherein:
the electronic device is a point-of-sale (POS) device.

7. The computer-implemented method of claim 6, wherein:
the electronic device is configured to display an option to allow the payment cardholder to initiate the replacement payment card request.

8. The computer-implemented method of claim 1, wherein:
the electronic device is an automated teller machine (ATM) or a kiosk.

9. A method, comprising:
configuring an electronic device to allow a payment cardholder to request a replacement payment card;
providing, at the electronic device, a request-a-replacement payment card prompt, the request-a-replacement payment card prompt being configured to allow the payment cardholder to request the replacement payment card;
ascertaining, upon selection of the request-a-replacement payment card prompt by the payment cardholder, replacement payment cardholder authorization information; and
utilizing the replacement payment cardholder authorization information to authorize a delivery of the replacement payment card for use by the payment cardholder.

10. The method of claim 9, wherein:
the electronic device is a point-of-sale (POS) device.

11. The method of claim 10, wherein:
the electronic device is associated with a merchant.

12. The method of claim 11, wherein:
the replacement payment card is delivered to the payment cardholder via the merchant.

13. The method of claim 12, wherein:
the replacement payment cardholder authorization information includes a payment-card-holder-specific personalized code (PC) unique to the payment cardholder.

14. The method of claim 13, wherein:
the replacement payment card is delivered to the payment cardholder via the merchant.

15. The method of claim 14, wherein:
the payment-card-holder-specific PC includes a pin code.

16. The method of claim 9, wherein:
the electronic device is an automated teller machine (ATM) or a kiosk.

17. A system, comprising:
a processor; and
a non-transitory computer readable medium coupled to the processor, the non-transitory computer readable medium including code that:
receives, from an electronic device, a replacement payment card request;
ascertains, as part of the replacement payment card request, a personalized code (PC) associated with a payment cardholder;
confirms an identity of the payment cardholder utilizing the PC in a replacement payment card authorization message;
based on the confirmation of the identity of the payment cardholder, provides the payment cardholder with a replacement payment card to an address indicated by the payment cardholder.

18. The system of claim 17, wherein:
the electronic device is associated with a merchant.

19. The system of claim 18, wherein:
the replacement payment card is delivered to the payment cardholder via the merchant.

20. The system of claim 19, wherein:
the PC is a payment-card-holder-specific PC unique to the payment cardholder.
